(19) United States
(12) Patent Application Publication
(10) Pub. No.: US 2023/0153577 A1
(43) Pub. Date: May 18, 2023

(54) TRUST-REGION AWARE NEURAL NETWORK ARCHITECTURE SEARCH FOR KNOWLEDGE DISTILLATION

(71) Applicant: QUALCOMM Incorporated, San Diego, CA (US)

(72) Inventors: Taehyeon KIM, Seoul (KR); Heesoo MYEONG, Seoul (KR)

(21) Appl. No.: 17/986,803

(22) Filed: Nov. 14, 2022

Related U.S. Application Data
(60) Provisional application No. 63/280,102, filed on Nov. 16, 2021.

(51) Int. Cl. G06N 3/04

(52) U.S. Cl. CPC G06N 3/0454

(57) ABSTRACT

A processor-implemented method of searching for a neural network architecture includes defining a search space of student neural network architectures for knowledge distillation. The search space includes multiple convolutional operators and multiple transformer operators. A trust-region Bayesian optimization is performed to select a student neural network architecture from the search space based on a pre-defined teacher model.

### CROSS-REFERENCE TO RELATED APPLICATION

The present application claims the benefit of U.S. Provisional Patent Application No. 63/280,102, filed on Nov. 16, 2021, and titled “TRUST-REGION AWARE NEURAL NETWORK ARCHITECTURE SEARCH FOR KNOWLEDGE DISTILLATION,” the disclosure of which is expressly incorporated by reference in its entirety.

### FIELD OF THE DISCLOSURE

Aspects of the present disclosure generally relate to neural network knowledge distillation, and more specifically to a sample-efficient trust-region aware neural network architecture search for knowledge distillation.

### BACKGROUND

Artificial neural networks may comprise interconnected groups of artificial neurons (e.g., neuron models). The artificial neural network may be a computational device or be represented as a method to be performed by a computational device. Convolutional neural networks are a type of feed-forward artificial neural network. Convolutional neural networks may include collections of neurons that each have a receptive field and that collectively tile an input space. Convolutional neural networks (CNNs), such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Large neural networks generally provide good results, but they may be computationally expensive. Knowledge may be distilled from the large neural network to a smaller neural network with the goal of achieving the same results with fewer computational resources. The large neural network may be referred to as a teacher neural network and the smaller neural network may be referred to as a student neural network. Models to search for and select the best student neural network architecture are computationally demanding despite their remarkable performance. Many researchers solve the scalability problem of an architecture search by formulating tasks in a differentiable manner or employing weight sharing techniques. However, differentiable methods may be unstable and not robust due to their relaxation properties, and weight-sharing techniques suffer rank disorder.

### SUMMARY

In aspects of the present disclosure, a processor-implemented method for searching for a neural network architecture includes defining a search space of student neural network architectures for knowledge distillation. The search space includes multiple convolutional operators and multiple transformer operators. The method further includes performing trust-region Bayesian optimization to select a student neural network architecture from the search space based on a pre-defined teacher model.

Other aspects of the present disclosure are directed to an apparatus for searching for a neural network architecture having a memory and one or more processor(s) coupled to the memory. The processor(s) is configured define a search space of student neural network architectures for knowledge distillation. The search space includes multiple convolutional operators and multiple transformer operators. The processor(s) is further configured to perform trust-region Bayesian optimization to select a student neural network architecture from the search space based on a pre-defined teacher model.

In other aspects of the present disclosure, a non-transitory computer-readable medium having program code recorded thereon is disclosed. The program code is executed by a processor and includes program code to define a search space of student neural network architectures for knowledge distillation. The search space includes multiple convolutional operators and multiple transformer operators. The program code further includes program code to perform trust-region Bayesian optimization to select a student neural network architecture from the search space based on a pre-defined teacher model.

Other aspects of the present disclosure are directed to an apparatus for searching for a neural network architecture includes means for defining a search space of student neural network architectures for knowledge distillation. The search space includes multiple convolutional operators and multiple transformer operators. The apparatus further includes means for performing trust-region Bayesian optimization to select a student neural network architecture from the search space based on a pre-defined teacher model.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 illustrates a Trust-region Aware architecture search to Distill knowledge Effectively (TRADE) model, in accordance with aspects of the present disclosure.

FIG. 5 is a flow chart illustrating an example method of searching for a neural network architecture, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Knowledge distillation (KD) has recently emerged as a popular method for compressing neural networks. The KD performance depends on the architecture's category as well as its output distribution, however, most methods do not consider the parameters and architecture of the student neural network model. While recent works present automatic architecture search methods for knowledge distillation, these search methods require significant search time and do not consider transformer blocks in the search space, even though vision transformer networks may outperform classical convolutional architectures.

Aspects of the present disclosure introduces a new process, coined as Trust-region Aware architecture search to Distill knowledge Effectively (TRADE), which rapidly finds effective student architectures for knowledge distillation using trust-region-based Bayesian optimization techniques. During the search phase, TRADE chooses the trust-region of the search space and attempts to design the best optimal architecture on the trust-region by combining various block types, such as an inverted bottleneck convolution (MBConv) architecture, a Fuse MBConv architecture, and a transformer block. TRADE is formulated as a problem of minimizing a new KD-guided score that leverages the teacher's computational resources such as the number of parameters, floating point operations (FLOPS), and latency. During the query phase, the performance of the student model is improved to reach the target accuracy by regularizing the orthogonality of both the pointwise convolution and transformer operations.

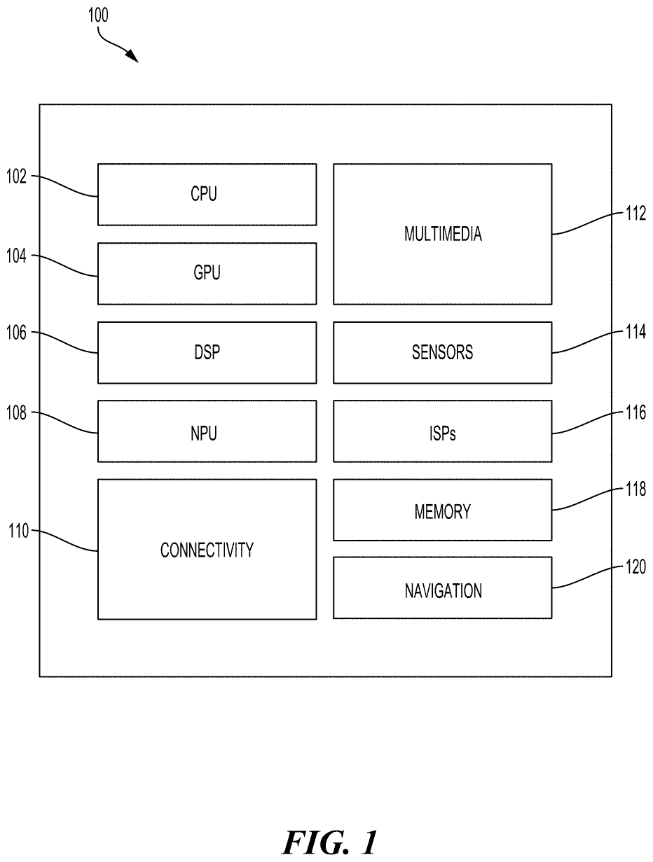

FIG. 1 illustrates an example implementation of a system-on-a-chip (SOC) 100, which may include a central processing unit (CPU) 102 or a multi-core CPU configured for neural architecture searching. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to define a search space of student neural network architectures for knowledge distillation. The search space including multiple convolutional operators and multiple transformer operators. The general-purpose processor 102 may also include code to perform trust-region Bayesian optimization to select a student neural network architecture from the search space based on a pre-defined teacher model.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

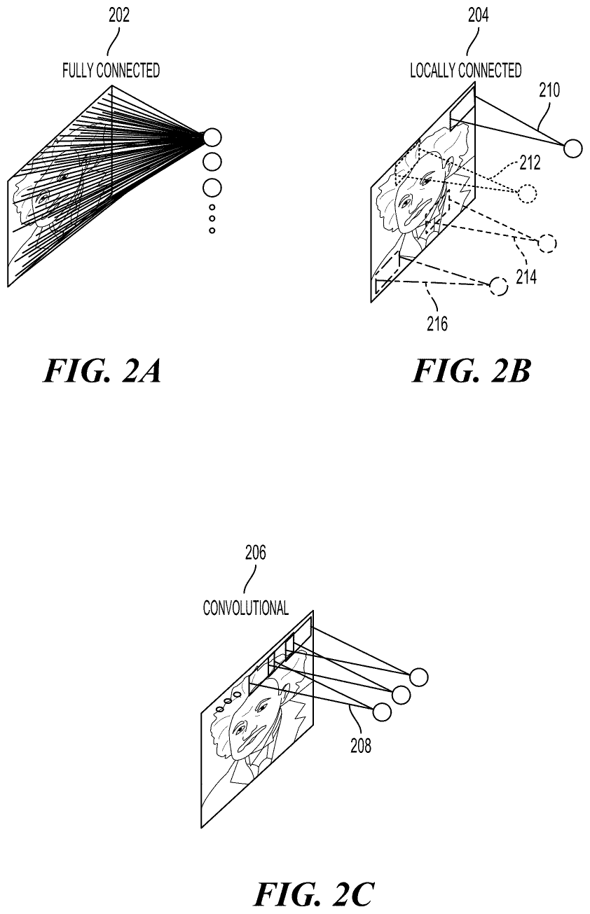

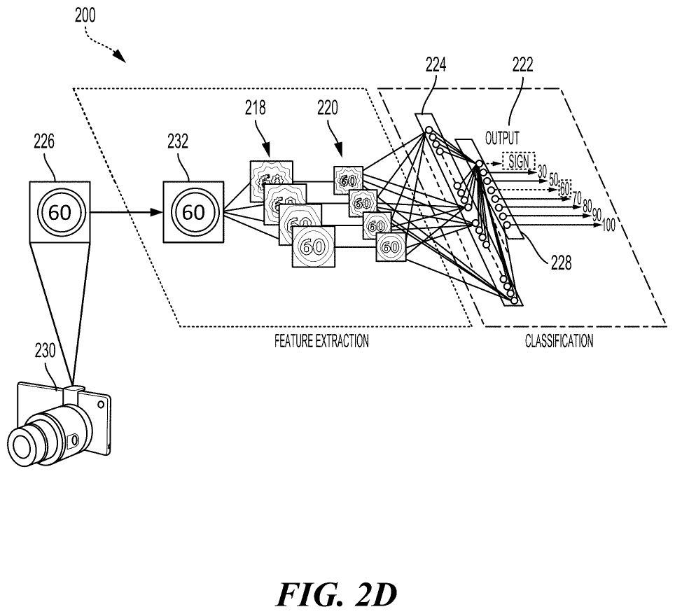

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

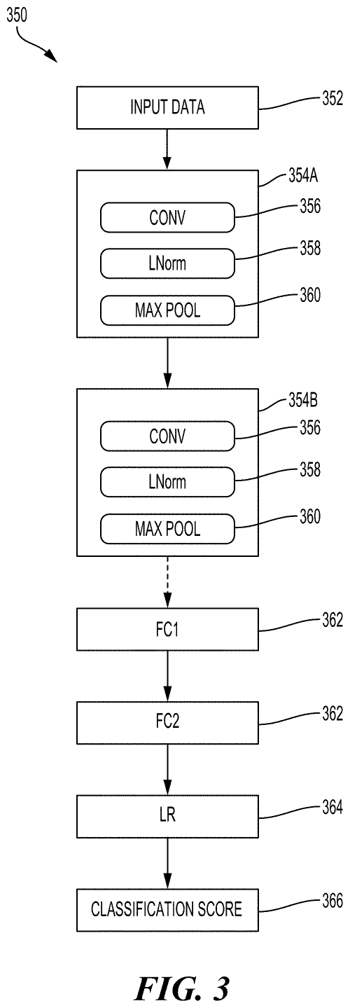

FIG. 3 is a block diagram illustrating a deep convolutional network (DCN) 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

Large neural networks generally provide good results, but they may be computationally expensive. Knowledge may be distilled from the large neural network to a smaller neural network with the goal of achieving the same results with fewer computational resources. Knowledge distillation is an effective way to compress neural networks. The large neural network may be referred to as a teacher neural network and the smaller neural network may be referred to as a student neural network. Models to search for and select the best student neural network architecture are computationally demanding despite their remarkable performance. Many researchers solve the scalability problem of an architecture search by formulating tasks in a differentiable manner or employing weight sharing techniques. However, differentiable methods may be unstable and not robust due to their relaxation properties, and weight-sharing techniques suffer rank disorder.

Aspects of the present disclosure address the scalability challenge of architecture searching by employing trust-region-based Bayesian optimization for knowledge distillation. Aspects of the present disclosure introduce a model referred to as a Trust-region Aware architecture search to Distill knowledge Effectively (TRADE). The new TRADE model rapidly finds effective student architectures with knowledge distillation using trust-region-based Bayesian optimization techniques. Training can be further facilitated by regularizing kernel orthogonality of both pointwise convolution and transformer operations. The student architecture for classification tasks transfers well to other downstream tasks.

The new TRADE model provides an improved or even optimal architecture family for knowledge distillation. The TRADE model saves orders of magnitude design cost compared to traditional neural network architecture search methods. The new TRADE technique employs Bayesian automated machine learning (AutoML). Aspects of the present disclosure employ a trust-region Bayesian optimization (BO) technique for global optimization. The trust-region Bayesian optimization technique uses a collection of simultaneous local optimizations while providing highly sample-efficient optimization of multiple competing objectives. These competing objectives may include: (1) model accuracy, (2) latency, (3) multiply-accumulate operations (MACs) or floating-point operations (FLOPS), and (4) a number of parameters.

The new TRADE technique rapidly finds the best student model under a pre-defined teacher model without human intervention. TRADE designs a unified network from a search space having convolution and transformer operators, for example. Specifically, the search space may be designed to allow the convolutional layer to handle early visual processing while leaving the representation learning to the transformer stage.

In some aspects, a kernel orthogonality regularization may accelerate the training curve and simultaneously improve accuracy when applied only on pointwise convolution and feed-forward network layers of the transformer stage.

Multiple design choices are now discussed. Multi-objective optimization (MOO) has a goal of maximizing model accuracy as well as minimizing the latency, floating point operations (FLOPS), and a number of parameters. Although FLOPS are discussed, other types of operations, such as integer operations or MAC operations, may be minimized.

TRADE attempts to find the optimal architecture that minimizes the KD-guided score, as follows:

Score=S×Acc_{target}/(Acc_{student}(1[Acc_{target}≤Acc_{student}]+ε)) s=NP_{student}/NP_{teacher}+FLOPS_{student}/FLOPS_{teacher}+Latency_{student}/Latency_{teacher},

where 1[⋅] is the indicator function, which is 1 when the statement inside the brackets is true and 0 otherwise, Acc_{model} denotes the top1 accuracy of the model (e.g., student model or target), ε is a small number of a denominator for numerical stability, and NP denotes the number of parameters. Top1 accuracy denotes the model with the most accurate prediction, based on measuring a proportion of examples where the predicted label matches a single target label.

The TRADE process creates an architecture with a minimum target accuracy while becoming lighter as the value of s is lower. Unlike prior systems, this score designs candidates more specialized for distillation in that the score compresses and considers the teacher's resource budget at the same time.

A trust-region Bayesian optimization (TurBO) technique may be employed to search for the best architecture from the search space. TurBO uses different sub-regions, called trust-regions, to perform multiple BO processes. After that, TurBO finds the next promising candidate through implicit Thompson sampling. In some implementations, the TurBO technique in the TRADE framework proceeds along the following steps:

1. Initial architectures are sampled from a Latin hypercube sampling.

2. A Gaussian process is trained with the previous observations. Then, the Gaussian process samples the Sobol sequence from the bounded region and selects promising candidates by computing their likelihood.

3. If the candidate turns out to be the new best point, TurBO perceives success and doubles a length of a corresponding trust-region. For all the other cases, TurBO recognizes it as a failure and halves the length of the corresponding trust-region. If the rescaled length reaches a certain maximum or minimum threshold, the trust-region restarts from the original length.

Aspects of the present disclosure investigate optimal hyperparameter settings of TRADE. A larger batch size leads the surrogate model to find a better optima. For a quick restarter of TRADE, aspects of the present disclosure close the gap between the minimum threshold and maximum threshold of its hyper-rectangle and settle down the tolerance at two, which controls the trade-off between exploitation and exploration.

In some implementations, the search space of the present disclosure consists of eight pre-defined blocks, although numbers other than eight are also contemplated. Each block contains a list of identical layers. Aspects of the present disclosure jointly search the optimal combination of convolution blocks and transformer blocks for architecture aware knowledge distillation by looking at all operators. If a transformer block is not used, it is designated to connect a convolutional backbone and head. The search space allows a search for a number of layers, a convolution block type, the usage of transformer blocks, a skip operation type, a convolution kernel size, a squeeze-and-excite ratio, and an input/output filter size, for each block independently.

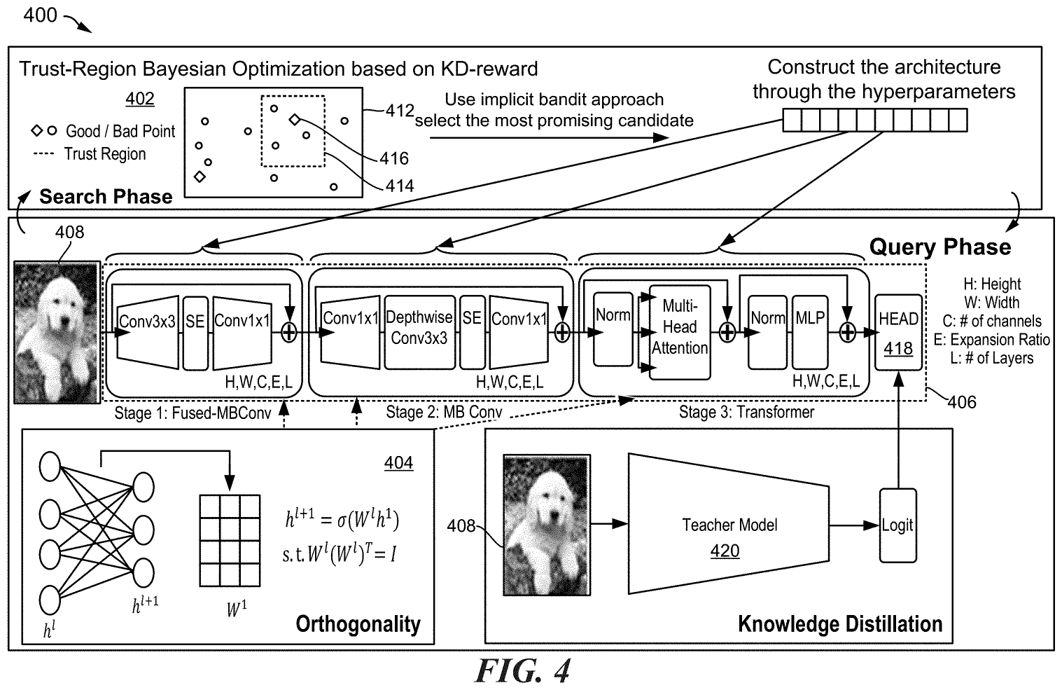

FIG. 4 illustrates a Trust-region Aware architecture search to Distill knowledge Effectively (TRADE) model, in accordance with aspects of the present disclosure. FIG. 4 shows an overall neural network architecture search flow 400, which consists of three major components: a BO technique for architecture search 402, a search space 404 for multiple operators, and a training environment 406. The training environment 406 includes knowledge distillation. In the BO technique for architecture search phase, the TRADE model jointly searches for an optimal combination of convolution and transformer operations for the design of a student model. The search uses a trust-region BO technique based on multiple competing objectives including the knowledge distillation-reward.

The knowledge distillation guided Bayesian neural network architecture search leverages trust-region Bayesian optimization (TurBO) for neural network architecture searching to rapidly explore student architectures. Initially, random models are selected from the search space for multiple operators 404 including convolutional and transformer operations. For example, the process determines whether to select a convolutional model(s) and/or a transformer operation. In the example of FIG. 4, the task is image recognition and the two types of convolutional blocks selected are: a fused inverted residual block (Fused-MBConv) for a first stage (Stage 1), and an inverted residual block (MBConv) for a second stage (Stage 2), in addition to a transformer block for a third stage (Stage 3). In the example of FIG. 4, the Fused-MBConv (Stage 1) operation includes a 3×3 convolutional portion, a lx1 convolutional portion, and a squeeze and excitation (SE) portion. The MBConv (Stage 2) operation includes a pair of 1×1 convolutional portions, a depthwise convolutional 3×3 portion, and a squeeze and excite (SE) portion. The transformer (Stage 3) operation includes a pair of normalization portions, a multi-head attention portion, and a multilayer perceptron (MLP) portion. Although not shown in FIG. 4, the model may include a Stem stage prior to the first stage (Stage 1). The Stem stage creates compact features of an input image 408 for the architecture search.

For the initial model of the search phase, hyperparameters for the transformer and convolutional operations may be randomly selected. Examples of hyperparameters include the height and width of the model, the number of model channels, the expansion ratio, and the number of model layers.

A teacher model 420 receives the image 408 as input. A student model head 418 is trained to mimic the logit output from the teacher model 420 using knowledge distillation and/or individual tasks loss.

The process calculates a knowledge distillation (KD)-guided score for the initially selected knowledge distillation model, after training the model. An overall search space 412 of all combinations of hyperparameters and models is quite large. Thus, a trust region 414 is defined for searching. Based on the KD-guided score, t-region Bayesian optimization is performed to minimize the KD-guided score and find good and bad points within the overall search space 412 and within the trust region 414. A most promising candidate 416 inside the trust region 414 is selected. The most promising candidate 416 may be selected with a well-known bandit algorithm, such as Thompson sampling.

A new architecture is constructed with hyperparameters corresponding to the selected most promising candidate 416. After training the new architecture, a KD-guided score of the new neural network architecture is calculated. A new trust region 414 is then determined based on the new architecture, and the process repeats until a predetermined number of iterations have completed.

In order to calculate the KD-guided score, a trained model from the training environment 406 receives the input image 408. In the example of FIG. 4, the trained model includes a Stem layer (not shown), the Fused-MBConv (Stage 1), MBConv (Stage 2), a transformer block (Stage 3), and the student model head 418. The student model head 418 is an output layer that performs the prediction based on output from the third stage (Stage 3). In the example of FIG. 4, the student model head 418 infers whether or not the image 408 is a dog.

After training, the student model head 418 and the logit of teacher model 420 are used to evaluate accuracy of a test and/or validation dataset. Finally, a KD-guided score is obtained using the obtained accuracy, number of parameters, flops, and latency of each teacher/student model. The entire process repeats for a number of different input images 408 to obtain the KD-guided score.

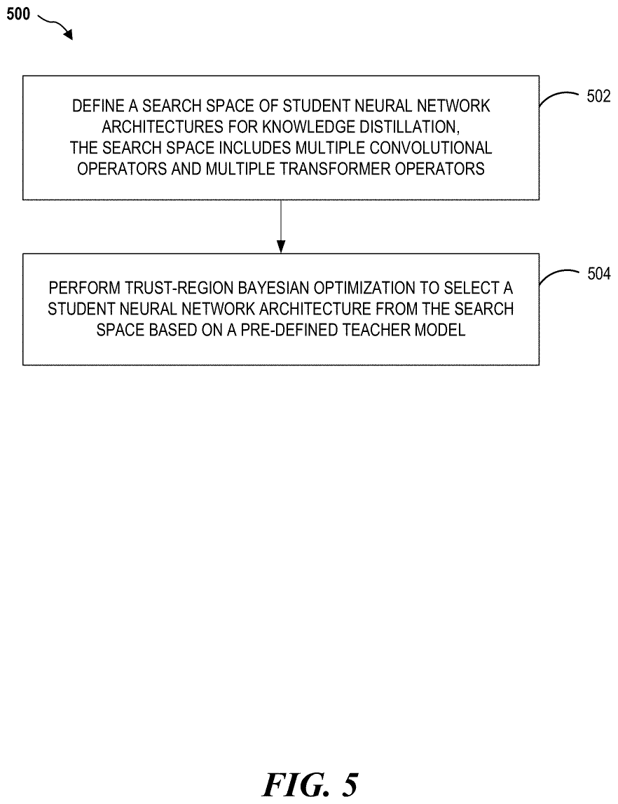

FIG. 5 is a flow chart illustrating an example method 500 of searching for a neural network architecture, in accordance with aspects of the present disclosure. As shown in FIG. 5, at block 502, the neural network architecture defines a search space of student neural network architectures for knowledge distillation. The search space includes a number of convolutional operators and a number of transformer operators. In some aspects, the search space assigns the convolutional operators to visual processing and the transformer operators to representation learning.

At block 504, the neural network architecture performs trust-region Bayesian optimization to select a student neural network architecture from the search space based on a pre-defined teacher model. In some aspects, performing the trust-region Bayesian optimization comprises performing simultaneous local optimizations with competing objectives, such as (but not limited to) model accuracy, a number of parameters, operations per second, and latency.

### Example Aspects

Aspect 1: A processor-implemented method, comprising defining a search space of student neural network architectures for knowledge distillation, the search space including a plurality of convolutional operators and a plurality of transformer operators; and performing trust-region Bayesian optimization to select a student neural network architecture from the search space based on a pre-defined teacher model.

Aspect 2: The processor-implemented method of Aspect 1, in which performing the trust-region Bayesian optimization comprises performing a plurality of simultaneous local optimizations with a plurality of competing objectives.

Aspect 3: The processor-implemented method of Aspects 1 or 2, in which the plurality of competing objectives includes one or more of model accuracy, a number of parameters, operations per second, and latency.

Aspect 4: The processor-implemented method of any of the preceding Aspects, in which the search space assigns the convolutional operators to visual processing and the transformer operators to representation learning.

Aspect 5: The processor-implemented method of any of the preceding Aspects, further comprising regularizing kernel orthogonality for pointwise convolution operations.

Aspect 6: The processor-implemented method of any of the preceding Aspects, further comprising regularizing kernel orthogonality for a feed-forward network layers in the transformer operators.

Aspect 7: An apparatus for searching for a neural network architecture, comprising: a memory; and at least one processor coupled to the memory, the at least one processor configured: to define a search space of student neural network architectures for knowledge distillation, the search space including a plurality of convolutional operators and a plurality of transformer operators; and to perform trust-region Bayesian optimization to select a student neural network architecture from the search space based on a pre-defined teacher model.

Aspect 8: The apparatus of Aspect 7, in which the at least one processor is configured to perform the trust-region Bayesian optimization by performing a plurality of simultaneous local optimizations with a plurality of competing objectives.

Aspect 9: The apparatus of Aspect 7 or 8, in which the plurality of competing objectives includes one or more of model accuracy, a number of parameters, operations per second, and latency.

Aspect 10: The apparatus of any of the Aspects 7-9, in which the search space assigns the convolutional operators to visual processing and the transformer operators to representation learning.

Aspect 11: The apparatus of any of the Aspects 7-10, in which the at least one processor is configured to regularize kernel orthogonality for pointwise convolution operations.

Aspect 12: The apparatus of any of the Aspects 7-11, in which the at least one processor is configured to regularize kernel orthogonality for a feed-forward network layers in the transformer operators.

Aspect 13: A non-transitory computer-readable medium having program code recorded thereon, the program code executed by a processor and comprising: program code to define a search space of student neural network architectures for knowledge distillation, the search space including a plurality of convolutional operators and a plurality of transformer operators; and program code to perform trust-region Bayesian optimization to select a student neural network architecture from the search space based on a pre-defined teacher model.

Aspect 14: The non-transitory computer-readable medium of Aspect 13, in which the program code to perform the trust-region Bayesian optimization comprises program code to perform a plurality of simultaneous local optimizations with a plurality of competing objectives.

Aspect 15: The non-transitory computer-readable medium of Aspect 13 or 14, in which the plurality of competing objectives includes one or more of model accuracy, a number of parameters, operations per second, and latency.

Aspect 16: The non-transitory computer-readable medium of any of the Aspects 13-15, in which the search space assigns the convolutional operators to visual processing and the transformer operators to representation learning.

Aspect 17: The non-transitory computer-readable medium of any of the Aspects 13-16, in which the program code further comprises program code to regularize kernel orthogonality for pointwise convolution operations.

Aspect 18: The non-transitory computer-readable medium of any of the Aspects 13-17, in which the program code further comprises program code to regularize kernel orthogonality for a feed-forward network layers in the transformer operators.

Aspect 19: An apparatus for searching for a neural network architecture, comprising: means for defining a search space of student neural network architectures for knowledge distillation, the search space including a plurality of convolutional operators and a plurality of transformer operators; and means for performing trust-region Bayesian optimization to select a student neural network architecture from the search space based on a pre-defined teacher model.

Aspect 20: The apparatus of Aspect 19, in which means for performing the trust-region Bayesian optimization comprises means for performing a plurality of simultaneous local optimizations with a plurality of competing objectives.

Aspect 21. The apparatus of Aspect 19 or 20, in which the plurality of competing objectives includes one or more of model accuracy, a number of parameters, operations per second, and latency.

Aspect 22. The apparatus of any of the Aspects 19-21, in which the search space assigns the convolutional operators to visual processing and the transformer operators to representation learning.

Aspect 23: The apparatus of any of the Aspects 19-22, further comprising means for regularizing kernel orthogonality for pointwise convolution operations.

Aspect 24: The apparatus of any of the Aspects 19-23, further comprising means for regularizing kernel orthogonality for a feed-forward network layers in the transformer operators.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method, comprising:
defining a search space of student neural network architectures for knowledge distillation, the search space including a plurality of convolutional operators and a plurality of transformer operators; and
performing trust-region Bayesian optimization to select a student neural network architecture from the search space based on a pre-defined teacher model.

2. The processor-implemented method of claim 1, in which performing the trust-region Bayesian optimization comprises performing a plurality of simultaneous local optimizations with a plurality of competing objectives.

3. The processor-implemented method of claim 2, in which the plurality of competing objectives includes one or more of model accuracy, a number of parameters, operations per second, and latency.

4. The processor-implemented method of claim 1, in which the search space assigns the convolutional operators to visual processing and the transformer operators to representation learning.

5. The processor-implemented method of claim 1, further comprising regularizing kernel orthogonality for pointwise convolution operations.

6. The processor-implemented method of claim 1, further comprising regularizing kernel orthogonality for a feed-forward network layers in the transformer operators.

7. An apparatus for searching for a neural network architecture, comprising:
a memory; and
at least one processor coupled to the memory, the at least one processor configured to:
define a search space of student neural network architectures for knowledge distillation, the search space including a plurality of convolutional operators and a plurality of transformer operators; and
perform trust-region Bayesian optimization to select a student neural network architecture from the search space based on a pre-defined teacher model.

8. The apparatus of claim 7, in which the at least one processor is further configured to perform the trust-region Bayesian optimization by performing a plurality of simultaneous local optimizations with a plurality of competing objectives.

9. The apparatus of claim 8, in which the plurality of competing objectives includes one or more of model accuracy, a number of parameters, operations per second, and latency.

10. The apparatus of claim 7, in which the search space assigns the convolutional operators to visual processing and the transformer operators to representation learning.

11. The apparatus of claim 7, in which the at least one processor is further configured to regularize kernel orthogonality for pointwise convolution operations.

12. The apparatus of claim 7, in which the at least one processor is further configured to regularize kernel orthogonality for a feed-forward network layers in the transformer operators.

13. A non-transitory computer-readable medium having program code recorded thereon, the program code executed by a processor and comprising:
program code to define a search space of student neural network architectures for knowledge distillation, the search space including a plurality of convolutional operators and a plurality of transformer operators; and
program code to perform trust-region Bayesian optimization to select a student neural network architecture from the search space based on a pre-defined teacher model.

14. The non-transitory computer-readable medium of claim 13, in which the program code to perform the trust-region Bayesian optimization comprises program code to perform a plurality of simultaneous local optimizations with a plurality of competing objectives.

15. The non-transitory computer-readable medium of claim 14, in which the plurality of competing objectives includes one or more of model accuracy, a number of parameters, operations per second, and latency.

16. The non-transitory computer-readable medium of claim 13, in which the search space assigns the convolutional operators to visual processing and the transformer operators to representation learning.

17. The non-transitory computer-readable medium of claim 13, in which the program code further comprises program code to regularize kernel orthogonality for pointwise convolution operations.

18. The non-transitory computer-readable medium of claim 13, in which the program code further comprises program code to regularize kernel orthogonality for a feed-forward network layers in the transformer operators.

19. An apparatus for searching for a neural network architecture, comprising:
means for defining a search space of student neural network architectures for knowledge distillation, the search space including a plurality of convolutional operators and a plurality of transformer operators; and
means for performing trust-region Bayesian optimization to select a student neural network architecture from the search space based on a pre-defined teacher model.

20. The apparatus of claim 19, in which the means for performing trust-region Bayesian optimization comprises means for performing a plurality of simultaneous local optimizations with a plurality of competing objectives.

21. The apparatus of claim 20, in which the plurality of competing objectives includes one or more of model accuracy, a number of parameters, operations per second, and latency.

22. The apparatus of claim 19, in which the search space assigns the convolutional operators to visual processing and the transformer operators to representation learning.

23. The apparatus of claim 19, further comprising means for regularizing kernel orthogonality for pointwise convolution operations.

24. The apparatus of claim 19, further comprising means for regularizing kernel orthogonality for a feed-forward network layers in the transformer operators.
